(19) United States
(12) Patent Application Publication
(10) Pub. No.: US 2025/0292050 A1
(43) Pub. Date: Sep. 18, 2025

(54) REAL-TIME IMAGE PROCESSING AND PRINTING CONTROL IN CARD PERSONALIZATION MACHINES

(71) Applicant: Entrust Corporation, Shakopee, MN (US)

(72) Inventors: Brendan Hinnenkamp, Shakopee, MN (US); Tom Wagener, Shakopee, MN (US)

(21) Appl. No.: 19/079,158

(22) Filed: Mar. 13, 2025

Related U.S. Application Data
(60) Provisional application No. 63/565,299, filed on Mar. 14, 2024.

(51) Int. Cl. G06K 15/02; B41M 3/00; B41M 5/00; G06K 19/077

(52) U.S. Cl. CPC G06K 15/189; B41M 3/005; B41M 5/0064; G06K 19/0772; G06K 2215/0094

(57) ABSTRACT

Systems and methods where at least one intended printing parameter of a printing mechanism of a card personalization system is modified in real-time to a new printing parameter just prior to printing on the card to tailor the printing parameter(s) from one card to the next. The modification of the intended printing parameter(s) may occur after the card has been input from a card input of the card personalization system. The printing parameter(s) used by the printing mechanism to print on each card can be modified in real-time so that the printing that is performed on each card can be improved.

### RELATED APPLICATION

This application claims priority to U.S. Provisional Application No. 63/565,299, filed Mar. 14, 2024, the disclosure of which is incorporated herein by reference

### FIELD

This technical disclosure relates to processing personalized identification documents such as personalized cards and pages of passports, and to modify an intended printing parameter of the printing mechanism based on specifics of the printing to be performed on each card/passport page.

### BACKGROUND

When printing multi-color images on personalized cards, the printing that occurs from one card to the next (i.e. the image that is printed on each card) can vary. Currently, the same printing parameters are used to print each image on each card. To optimize the printing on each card, it may be desirable for the printing mechanism to use different printing parameters to print each image on each card.

### SUMMARY

Systems and methods are described where at least one intended printing parameter of a printing mechanism of a card personalization system is modified in real-time to a new printing parameter just prior to printing on the personalized card to tailor the printing parameter(s) to the card. The modification of the intended printing parameter(s) to the new printing parameter may occur after the card has been input from a card input of the card personalization system. The printing parameter(s) used by the printing mechanism to print an image on each card can be modified to the new printing parameter(s) in real-time so that the printing that is performed on each card and the resulting aesthetics of the printing can be improved.

The intended printing parameter that is modified to the new printing parameter may be based on and included in the image data of the image to be printed. For example, the image data may dictate that a particular printing parameter be used, however that intended printing parameter can be modified to a new printing parameter that would result in an improved aesthetic of the printed image. In another embodiment, the intended printing parameter that is modified may be based on the operation of and is a programmed/default setting of the printing mechanism. For example, the printing mechanism may be programmed and controlled to operate in one manner, for example at an intended card transport speed, to pin or not pin, to cure or not cure, to pre-treat the card or not pre-treat the card and/or other printing parameter, while printing on each card. However, it may be determined by the system that the best aesthetic of the printed image on a particular card would be achieved with a different card transport speed and/or another printing parameter. Therefore, the card transport speed (or other printing parameter) of the printing mechanism can be modified to a new card transport speed to print on the next card in sequence. The modification could be temporary in which case the printing mechanism automatically reverts back to the original printing parameter after printing, or the modification could be permanent until modified again prior to printing on another card.

In one embodiment, a method of printing an image on a card in a card personalization system having a printing mechanism includes inputting, from a card input, the card onto a card path of the card personalization system. After the card has been input onto the card path, image data of the image to be printed on the card is processed in the card personalization system to modify an intended printing parameter associated with the image data to a new printing parameter. Thereafter, at least a portion of the image is printed on the card using the printing mechanism using the new printing parameter. The resulting image that is printed has improved aesthetics due to use of the new printing parameter.

In another embodiment, a method of printing images on cards in a card personalization system having a printing mechanism includes printing in sequence in the printing mechanism a first image on a first card and a second image on a second card. Printing the first image on the first card comprises using a first set of printing parameters that are generated after the first card is input from a card input onto a card path of the card personalization system, where the first set of printing parameters includes at least one new first printing parameter that is generated based on an intended first printing parameter of first image data of the first image. In addition, printing the second image on the second card comprises using a second set of printing parameters that are generated after the second card is input from the card input mechanism onto the card path of the card personalization system, where the second set of printing parameters includes at least one new second printing parameter that is generated based on an intended second printing parameter of second image data of the second image. In addition, the second set of printing parameters differs from the first set of printing parameters, due to the generation of the new printing parameters from the intended printing parameters, so that the printing of the first image on the first card is tailored for the first card and the printing of the second image on the second card is tailored for the second card.

In another embodiment, the modification of the intended printing parameter(s) to the new printing parameter may occur prior to the card being input from the card input of the card personalization system. For example, the data processing resulting in the modification may occur at a location physically separate or remote from the card personalization system, for example in a cloud-based data processing system or remote server, with the processed data being provided to the card personalization system prior to feeding the card from the card input. Alternatively, the data processing resulting in the modification may occur on the card personalization system but prior to the card being input. In another embodiment, the data processing resulting in the modification may occur prior to the card being input, but the processed data not being provided to the card personalization system (in the case of remote data processing) until after the card is input.

In an embodiment, a method of printing images on cards in a card personalization system having a printing mechanism can include printing in sequence in the printing mechanism a first image on a first card and a second image on a second card. Printing the first image on the first card can include using a first set of printing parameters, the first set of printing parameters includes at least one new first printing parameter that is generated based on an intended first printing parameter. In addition, printing the second image on the second card can include using a second set of printing parameters, the second set of printing parameters includes at least one new second printing parameter that is generated based on an intended second printing parameter. The second set of printing parameters differs from the first set of printing parameters. In an embodiment, the at least one new first printing parameter can be generated after the first card is input from a card input onto a card path of the card personalization system, and the at least one new second printing parameter can be generated after the second card is input from the card input onto the card path of the card personalization system. In another embodiment, the first set of printing parameters may be generated prior to the first card being input from a card input onto a card path of the card personalization system, and the second set of printing parameters may be generated prior to the second card being input from the card input onto the card path of the card personalization system. In another embodiment, the first set of printing parameters and the second set of printing parameters may both be generated at a location physically separate from the card personalization system.

### DRAWINGS

FIG. 1A is a view of an example of a front surface of a card.

FIG. 1B is a view of an example of a rear surface of a card.

FIG. 2 illustrates a method of printing an image on a card according to one embodiment.

FIG. 3 illustrates another method of printing images on cards according to another embodiment.

FIG. 4 illustrates another method of printing images on cards according to another embodiment.

FIG. 5 schematically depicts an example of a card personalization system that can implement the methods described herein.

### DETAILED DESCRIPTION

Card personalization systems and printing methods using such systems are described. The systems and methods described herein tailor the printing parameter(s) used by the printing mechanism of the card personalization system to print respective images on each card by modifying at least one intended printing parameter to a new printing parameter in real-time so that the printing that is performed on each card can be improved.

In an embodiment, the cards described herein may be plastic cards. The cards (or personalized identification cards) described herein include, but are not limited to, financial (e.g., credit, debit, or the like) cards, access cards, driver's licenses, national identification cards, and business identification cards, and other identification cards. In an embodiment, the cards may be ID-1 cards as defined by ISO/IEC 7810. However, other card formats such as ID-2 as defined by ISO/IEC 7810 are possible as well. For the sake of simplicity in describing the concepts herein, the identification cards may be described below and/or claimed as being cards. However, the concepts described in this patent application can be applied to pages, such as plastic pages, of passports as well. The passport pages can be a front cover or a rear cover of the passport, or an internal page (for example a page referred to as a data page) of the passport. In an embodiment, the passports may be in an ID-3 format as defined by ISO/IEC 7810.

The term “card” or “identification card” as used throughout the specification and claims, unless indicated otherwise, refers to cards where the card substrate can be formed entirely of a material such as plastic, or formed of a combination of materials such as plastic and non-plastic materials. In one embodiment, the cards can be sized to comply with ISO/IEC 7810 with dimensions of about 85.60 by about 53.98 millimeters (about 3⅜ in×about 2⅛ in) and rounded corners with a radius of about 2.88-3.48 mm (about 1/8 in). As would be understood by a person of ordinary skill in the art of identification cards, the cards are typically formed of multiple individual layers that form the majority of the card body or the card substrate. Similarly, the term “page” of a passport refers to passport pages where the passport can be formed entirely of a material such as plastic, or formed of a combination of materials such as plastic and non-plastic materials. An example of a passport page is the data page in a passport containing the personal data of the intended passport holder. The passport page may be a single layer or composed of multiple layers.

In the case of a plastic card, examples of plastic materials that the plastic card (or passport page), or the individual layers of the card or passport can be formed from include, but are not limited to, polyvinyl chloride (PVC) and derivatives, polycarbonate, polyester, acrylonitrile butadiene styrene (ABS), polyethylene terephthalate glycol (PETG), TESLIN®, polylactic acid (PLA), combinations thereof, and other plastics. In the case of a non-plastic card, examples of materials include paper and wood. In some embodiments, a card can be made from combinations of these or other plastic and non-plastic materials.

The term “personalization” (or the like) as used throughout the specification and claims, unless indicated otherwise, is intended to encompass operations performed on a card that includes operations that result in personalizing the card as well as operations that do not result in personalizing the card. An example of a personalization operation that personalizes the card is printing the cardholder's image or name on the card. An example of a personalization operation that does not personalize the card is printing non-card holder graphics on the card. The term “personalize” is often used in the personalized card industry to refer to card that undergo both personalization processing operations and non-personalization processing operations.

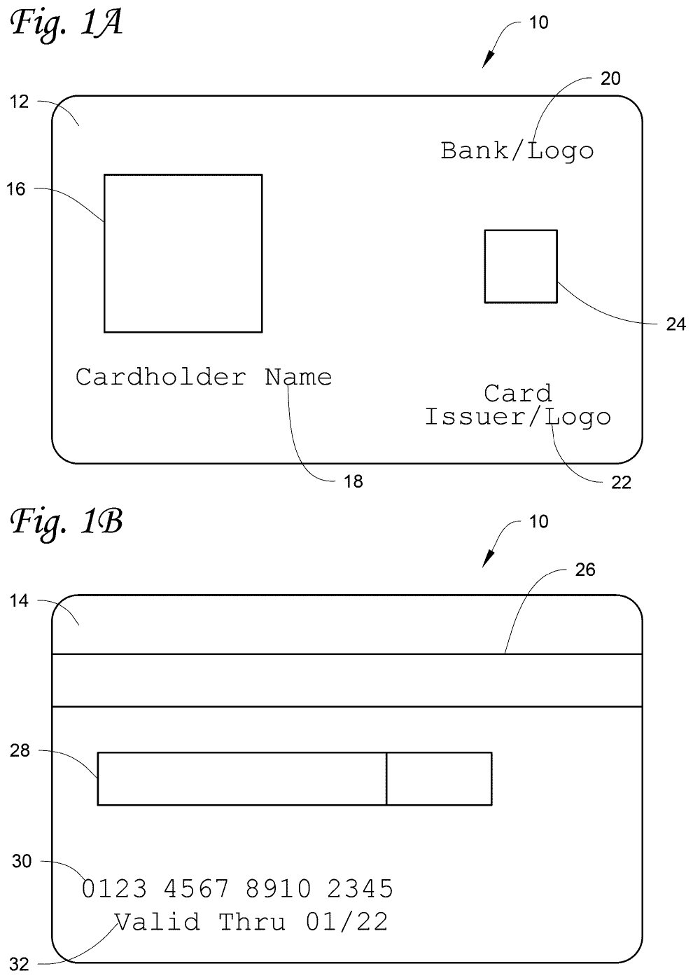

FIGS. 1A and 1B illustrate an example of a card 10. In this example, the card 10 is shown to include a front or first surface 12 (FIG. 1A) and a rear, back or second surface 14 (FIG. 1B) opposite the front surface 12. The card 10 may have various forms of printing on one side only (referred to as simplex printing), for example on the front surface 12 or the rear surface 14, or printing on both sides (referred to as duplex printing), for example on each of the front surface 12 and the rear surface 14.

Many possible layouts for the front surface 12 are possible. For example, the front surface 12 can include a horizontal card layout, a vertical card layout, and other known layout configurations and orientations. In the illustrated example in FIG. 1A, the front surface 12 can include various printed cardholder data such as a multi-color printed portrait image 16, the cardholder name 18, and account information such as account number, expiration date and the like. The front surface 12 may also include a multi-color printed background image which typically covers the majority of or the entirety of the front surface 12 (except not over an integrated circuit chip). The front surface 12 can also include other printed data such as printed information 20 of the entity that issued the card 10, such as the corporate name and/or logo of the issuing bank (for example, STATE BANK), and/or printed information 22 of the card brand name (for example, VISA®, MASTERCARD®, DISCOVER®, etc.). The front surface 12 may also include a contact or contactless integrated circuit chip 24 that can store various data relating to the card 10 such as an account number and/or name of the cardholder.

Referring to FIG. 1B, many possible layouts for the rear surface 14 are possible which may or may not have a similar layout as the front surface 12. For example, the rear surface 14 can include a horizontal card layout, a vertical card layout, and other known layout configurations and orientations. In the illustrated example in FIG. 1B, the rear surface 14 can include a magnetic strip 26 that stores various data relating to the card 10 such as an account number or name of the cardholder, a signature panel 28 that provides a place for the cardholder to sign their name, and a hologram. The magnetic strip 26, the signature panel 28, and the hologram are conventional elements found on many cards. The rear surface 14 can also include printed personal data that is unique to or assigned specifically to the cardholder. For example, an account number 30 assigned to the cardholder, the name of the cardholder, and a card expiration date 32 can be printed on the rear surface 14. Other personal cardholder data may also be printed on the rear surface 14, such as an image of the face of the cardholder. Non-personal data such as the name of the issuing bank, contact information to contact the issuing bank, and the like, can also be printed on the rear surface 14. The rear surface 14 can include a multi-color printed background image which covers the majority of or the entirety of the rear surface 14, except not over the magnetic strip 26 or the signature panel 28.

The printing methods described herein can apply to any printing that takes place on the front surface 12 or the rear surface 14 where one or more of the printing parameters used by the printing mechanism to perform the printing may need to be modified from one card to the next. The printing may be multi-color, monochromatic or gray-scale. The printing may be multi-color background images; multi-color, monochromatic or gray-scale portrait images; multi-color, monochromatic or gray-scale printed personal data; and other printing performed by a printing mechanism. Printing may also include processing that is associated with the actual printing of an image on the card such as curing applied ink (full curing or pinning (i.e. partial curing)), or conditioning the card surface prior to printing for example via plasma treatment.

The printing described herein can be drop-on-demand (DOD) printing using ink, thermal printing of radiation curable ink from a print ribbon, thermal printing of dye from a print ribbon, and any other type of printing where a dye or ink is applied to the card in a printing mechanism. Printing includes not only the act of applying ink/dye to the card surface but also follow-on processes to complete the printing process such as curing of the applied ink using radiation energy, or pre-processing of the card surface such as plasma treatment.

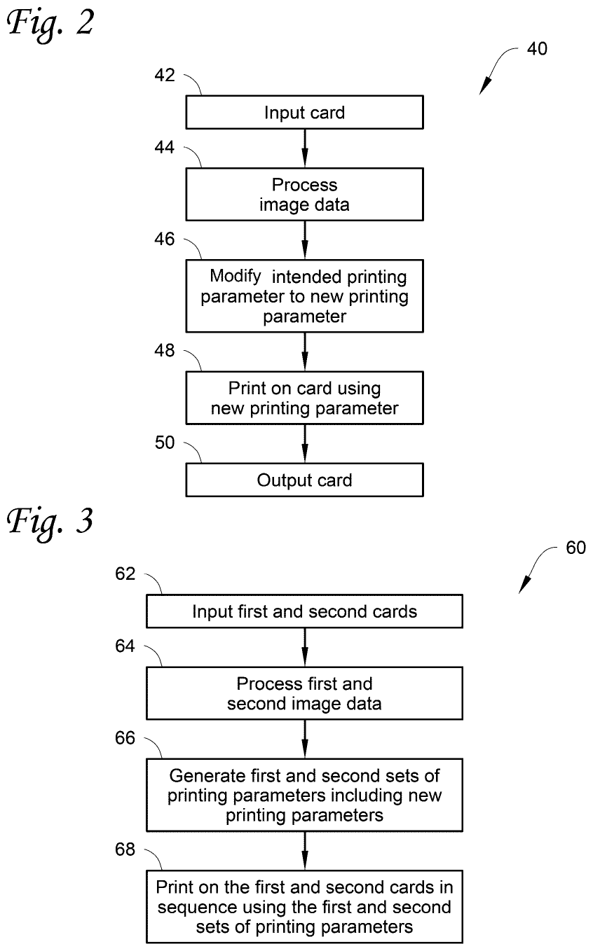

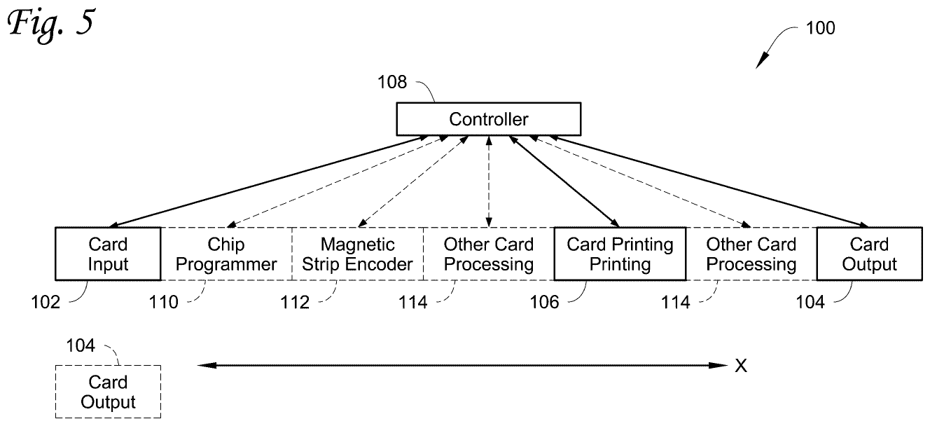

FIG. 2 illustrates a method 40 of printing an image on a card. The printing takes place in a card personalization system (an example of which is described below in FIG. 5) having a printing mechanism. In the method, in step 42, a card is input onto a card path of the card personalization system from a card input. In one embodiment, the card input can be an input hopper. In another embodiment, the card input can be an input slot through which individual cards are manually or automatically fed for processing. The card path is a path within at least a part of the card personalization system along which the card is transported.

After the card is input onto the card path and with the card in the card personalization system, in step 44 image data of the image to be printed on the card is processed to generate processed image data. In an embodiment, the processing of the image data takes place within the card personalization system, or locally outside of but close to the card personalization system for example in a computing system that is in communication with the card personalization system. In another embodiment, the processing of the image data occurs remote from the card personalization system, for example in the cloud or in a control system that is remote from and in communication with the card personalization system. In an embodiment, processing of the image data to be printed on the card can occur during programming of an integrated circuit chip on the card in the card personalization system or after the programming of the integrated circuit chip on the card in the card personalization system. In another embodiment, processing of the image data can occur during magnetic encoding of a magnetic strip on the card in the card personalization system or after the magnetic encoding of the magnetic strip on the card in the card personalization system. In an embodiment, the processed image data can include a plurality of color planes as described further below.

At step 46, based on the processed image data from step 44, at least one intended printing parameter is modified to generate a new printing parameter. Modifying the at least one intended printing parameter to generate the new printing parameter includes modifying at least one intended performance setting of the printing mechanism to a new performance setting that will be implemented by the printing mechanism to perform the printing. The modification from the intended printing parameter to the new printing parameter means that the image that is printed using the new printing parameter is different in some manner than the intended printed image if printed using the intended printing parameter. For example, the image that is printed using the new printing parameter has improved aesthetics compared to the same image if it were printed using the intended printing parameter.

The intended printing parameter that is modified to the new printing parameter can be any printing parameter such as, but not limited to, a printing parameter to improve the resulting aesthetic of the printed image. Examples of intended printing parameters of the printing mechanism that can be modified to a new printing parameter from one card to the next include, but are not limited to: modifying or adjusting an intended ratio of inks used to print different features on a card (for example, for text and an image to be printed, the amount of black ink intended to be used to print the text can be modified/adjusted relative to the intended amount of ink(s) specified in the image data to print the image); adjusting the overall amount of ink applied to a card from an intended amount (for example, an intended amount of ink could be associated with the card or with an image or text to be printed on the card, and the amount of ink could be adjusted based on analysis of the image or text data); modifying an intended resolution of the image; modifying an intended dot size of ink to be applied to the card during printing the image; speed of printing the image in the printing mechanism; temperature of the card surface, temperature of the thermal print head, and/or temperature of the ink during printing; delay time between printing the image and curing of ink or dye used to print the image; speed of curing; pin (i.e. partially cure) the radiation curable ink or no pinning; variable pinning by modifying the amount of radiation during partial curing or no pinning; the amount of radiation energy applied to ink during curing; the location(s) of applying the radiation to the card for curing; plasma treat or no plasma treatment of a card prior to printing; modifying the location of plasma treatment that occurs on the card; modifying the energy/intensity of the plasma treatment; and others.

Thereafter, at step 48, at least a portion of the image is printed on the card in the printing mechanism using the at least one new printing parameter. For example, in step 48, the image may be printed at a faster or slower speed compared to the initial intended speed; in the case of radiation curable ink, an intended delay time between printing the image and curing of ink or dye used to print the image may be altered to a new delay time (for example the delay time could be modified compared to the delay time used for the immediately preceding card); pinning may be implemented while no pinning was implemented on the prior card; etc. The printing in step 48 can be DOD printing or thermal printing from a print ribbon. The printed image may be a multi-color image, a monochromatic image, or a gray-scale image. The printed image may be a background image or a portrait image.

Once printing is complete and any further processing on the card is complete, the card is output at step 50 to a card output. The card output can be configured to hold a plurality of cards after they have been processed in the card personalization system. In this configuration, the card output is often termed a card output hopper. The construction and operation of card output hoppers is well known in the art. In another embodiment, the card output can be an output slot.

FIG. 3 illustrates another method 60 of printing an image on a card. The method 60 is most suitable for card personalization systems where first and second cards can be simultaneously present within the card personalization system after being fed from a card input, and the first and second cards are printed in sequence (i.e. one after the other without printing an intervening card(s)) with different sets of printing parameters. For example, an example of a card personalization system that can implement the method 60 (as well as the method 40) is a large volume batch production card processing system (sometimes referred to as a central issuance processing system). However, the card personalization system may also be configured as a desktop card processing system that is typically designed for relatively smaller scale, individual card personalization in relatively small volumes, for example measured in tens or low hundreds per hour (often termed desktop processing machines).

At step 62, the first and second cards are input into the card personalization system, for example from an input hopper or from an input slot. Even though the first and second cards are described as being printed in sequence, the first and second cards may be fed into the card personalization system in sequence or not in sequence.

At step 64, with the first and second cards in the card personalization system, first image data of the first image to be printed on the first card and second image data of the second image to be printed on the second card is processed to generate first processed image data and second processed image data. In an embodiment, the processing of the first image data and the second image data takes place within the card personalization system, or locally outside of but close to the card personalization system for example in a computing system that is in communication with the card personalization system. In another embodiment, the processing of the image data occurs remote from the card personalization system, for example in the cloud or in a control system that is remote from and in communication with the card personalization system. In an embodiment, processing of the first and second image data can occur during programming of integrated circuit chips on the first and second cards in the card personalization system or after the programming of the integrated circuit chips on the first and second cards in the card personalization system. In another embodiment, processing of the first and second image data can occur during magnetic encoding of magnetic strips on the first and second cards in the card personalization system or after the magnetic encoding of the magnetic strips on the first and second cards in the card personalization system.

At step 66, a first set of printing parameters, including at least one new first printing parameter that differs from an intended first printing parameter, is generated based on processing the first image data of the first image to be printed on the first card, and a second set of printing parameters, including at least one new second printing parameter that differs from an intended second printing parameter, is generated based on processing the second image data of the second image to be printed on the second card. The first and second sets of printing parameters can be generated based on the first and second processed image data, respectively, from step 64. The new printing parameters can be those described above or other new printing parameters that are modified from intended printing parameters. The first set of printing parameters differs from the second set of printing parameters whereby the printing parameters used to print the first image on the first card differ from the printing parameters used to print the second image on the second card.

Thereafter, at step 68, the first and second images are printed on the first and second cards in sequence using the first and second sets of printing parameters. For example, in step 68, an intended image parameter that was intended to be used to print the first image is modified to a new printing parameter and the first image is printed using the new printing parameter. For example, the printing parameter may relate to the speed used to conduct the printing and the second image may have initially been intended to have been printed on the second card at the same print speed as the printing on the first card, but a new printing speed for the second card is generated that causes the second card to be printed at a faster or slower speed compared to the speed used to print the first image on the first card; in the case of radiation curable ink, a delay time between printing the first image and curing of ink or dye used to print the first image may be altered compared to the delay time used for printing the second image on the second card; ink on the first card may be pinned while ink on the second may not be pinned; etc. The printing in step 68 can be DOD printing or thermal printing from a print ribbon. The first and second printed images may be multi-color images, monochromatic images, or gray-scale images. The first and second printed images may be background images, portrait images, or a combination thereof.

The result of the method 60 in FIG. 3 is that the first image and the second image are printed on the first card and the second card in sequence using different printing parameters of the printing mechanism, where the printing parameters are determined and modified in real-time while the first and second cards are in the card personalization system after being fed from the card input.

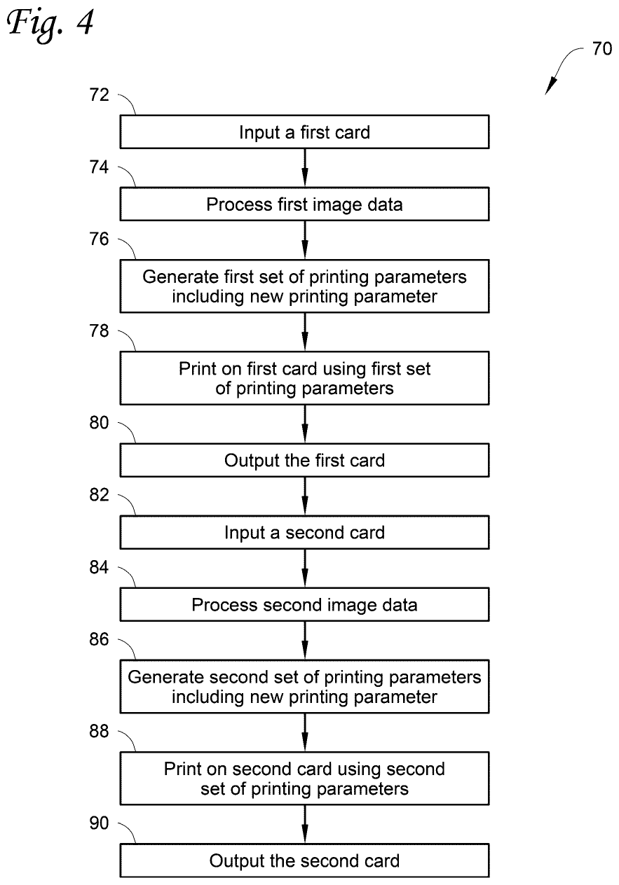

FIG. 4 illustrates another method 70 of printing an image on a card. The method 70 is most suitable for card personalization systems which process one card at a time within the card personalization system. For example, an example of a card personalization system that can implement the method 70 is a desktop card processing system. However, the method 70 can be utilized in other card personalization systems, such as card personalization systems where first and second cards can be simultaneously present within the card personalization system after being fed from a card input.

In step 72, a first card is input onto a card path of the card personalization system from a card input. In one embodiment, the card input can be an input hopper. In another embodiment, the card input can be an input slot through which individual cards are manually or automatically fed for processing. The card path is a path within at least a part of the card personalization system along which the card is transported.

After the first card is input onto the card path and with the first card in the card personalization system, in step 74 first image data of the image to be printed on the first card is processed to generate processed image data. In an embodiment, the processing of the image data takes place within the card personalization system, or locally outside of but close to the card personalization system for example in a computing system that is in communication with the card personalization system. In another embodiment, the processing of the image data occurs remote from the card personalization system, for example in the cloud or in a control system that is remote from and in communication with the card personalization system. In an embodiment, processing of the image data can occur during programming of an integrated circuit chip on the first card in the card personalization system or after the programming of the integrated circuit chip on the first card in the card personalization system. In another embodiment, processing of the image data can occur during magnetic encoding of a magnetic strip on the first card in the card personalization system or after the magnetic encoding of the magnetic strip on the first card in the card personalization system.

At step 76, a first set of printing parameters, including at least one new first printing parameter that is modified from an intended first printing parameter, is generated based on processing the first image data of the first image to be printed on the first card. The first set of printing parameters can be generated based on the first processed image data from step 74. The printing parameters can be those described above or other printing parameters.

Thereafter, at step 78, the first image is printed on the first card using the first set of printing parameters. The printing in step 78 can be DOD printing or thermal printing from a print ribbon. The first printed image may be a multi-color image, a monochromatic image or a gray-scale image. The first printed image may be a background image, a portrait image, or a combination thereof.

Once printing is complete and any further processing on the first card is complete, the first card is output at step 80 to a card output. The card output can be configured to hold a plurality of cards after they have been processed in the card personalization system. In this configuration, the card output is often termed a card output hopper. The construction and operation of card output hoppers is well known in the art. In another embodiment, the card output can be an output slot.

Thereafter, at step 82, a second card is input onto the card path of the card personalization system from the card input which can be an input hopper or an input slot through which individual cards are manually or automatically fed for processing. In an embodiment, the second card may be input after the printing in step 78 but prior to outputting the first card in step 80.

After the second card is input onto the card path and with the second card in the card personalization system, in step 84 second image data of the image to be printed on the second card is processed to generate processed image data. In an embodiment, the processing of the image data takes place within the card personalization system, or locally outside of but close to the card personalization system for example in a computing system that is in communication with the card personalization system. In another embodiment, the processing of the image data occurs remote from the card personalization system, for example in the cloud or in a control system that is remote from and in communication with the card personalization system. In an embodiment, processing of the image data can occur during programming of an integrated circuit chip on the second card in the card personalization system or after the programming of the integrated circuit chip on the second card in the card personalization system. In another embodiment, processing of the image data can occur during magnetic encoding of a magnetic strip on the second card in the card personalization system or after the magnetic encoding of the magnetic strip on the second card in the card personalization system.

At step 86, a second set of printing parameters, including at least one new second printing parameter that is modified from an intended second printing parameter, is generated based on processing the second image data of the second image to be printed on the second card. The second set of printing parameters can be generated based on the second processed image data from step 84. The printing parameters can be those described above or other printing parameters. The second set of printing parameters differs from the first set of printing parameters due to the generation of the first new printing parameter and the second new printing parameter whereby the printing parameters used to print the first image on the first card differ from the printing parameters used to printing the second image on the second card.

Thereafter, at step 88, the second image is printed on the second card using the second set of printing parameters. The second printed image may be a multi-color image, a monochromatic image or a gray-scale image. The second printed image may be a background image, a portrait image, or a combination thereof.

Once printing is complete and any further processing on the second card is complete, the second card is output at step 90 to the card output which can be a card output hopper or an output slot.

In any of the embodiments described herein, the modification of the intended printing parameter(s) to the new printing parameter(s) may occur prior to the card being input from the card input. For example, the data processing resulting in the modification may occur at a location physically separate or remote from the card personalization system, for example in a cloud-based data processing system or remote server, with the processed data being provided to the card personalization system prior to feeding the card from the card input. Alternatively, the data processing resulting in the modification may occur on the card personalization system but prior to the card being input. In another embodiment, the data processing resulting in the modification may occur prior to the card being input, but the processed data is not provided to the card personalization system (in the case of remote data processing) until after the card is input. In another embodiment, the data processing resulting in the modification may occur prior to the card being input, but the processed data is not provided to the card personalization system (in the case of remote data processing) until after the card is input. In another embodiment, the data processing resulting in the intended modification may occur prior to the card being input, but any change to the card personalization system (whether a mechanical change and/or a control software change) to implement the new printing parameter(s) does not actually take place until after the card is input or may take place just prior to the card being input after a preceding card has been printed.

Referring to FIG. 5, an example of a card personalization system 100 is depicted. In this example, the components of the system 100 are depicted as being arranged as a large volume batch production card processing system with a card input 102 and a card output 104 at opposite ends, a card printing mechanism 106 arranged between the input 102 and the output 104, and the cards transported by suitable transport mechanisms along a generally linear card transport path X. The cards can be transported in a forward direction (i.e. in a direction toward the output 104) along the transport path X and optionally in a reverse direction (toward the input 102). In this example, the printing mechanism 106 is between the input 102 and the output 104. FIG. 5 depicts an alternative location of the output 104 (depicted in broken lines), for example at the same end as the input 102, or the input 102 and the output 104 could have other relative positioning to one another. Such alternative positioning of the input 102 and/or the output 104 would be suitable when arranging the components of the system 100 as a desktop card processing system.

The card input 102 can be configured to hold a plurality of cards (or passports) waiting to be processed and that mechanically feeds the cards one by one into the card transport path X of the system 100 using a suitable card feeder known in the art. In one embodiment, the card input 102 can be an input hopper. In another embodiment, the card input 102 can be an input slot through which individual card are manually or automatically fed for processing. The card output 104 can be configured to hold a plurality of cards after they have been processed in the system 100. In this configuration, the card output 104 is often termed a card output hopper. The construction and operation of output hoppers is well known in the art. In another embodiment, the card output 104 can be an output slot.

The card printing mechanism 106 is a mechanism that is configured to apply printing to a portion of or the entire surface of the cards. Examples of printing that can be used include, but are not limited to, drop-on-demand (DOD) printing using ink, which may be curable by ultraviolet radiation, applied to the surface from one or more DOD print heads; direct-to-card thermal transfer printing where dye or other color material or other material is applied from one or more print ribbons via a thermal print head to the surface; or retransfer printing where an image is first printed on an intermediate material which is then transferred to the surface. An example of a DOD printer is described in U.S. Pat. No. 10,576,769 the entire contents of which are incorporated herein by reference. An example of a thermal transfer printer is described in U.S. Pat. No. 10,889,129 the entire contents of which are incorporated herein by reference. An example of a retransfer printer is described in U.S. Pat. No. 9,904,876 the entire contents of which are incorporated herein by reference.

The system 100 further includes a controller 108 that controls operation of the card input 102, the card output 104, the printing mechanism 106 and other components (if any) of the system 100, the transport of the card(s) within the system 100, etc. The controller 108 is any arrangement of hardware and/or software that controls operation of the system 100 including the components 102, 104, and 106. In particular, the controller 108 can perform the processing of the image data to be printed on the cards, can determine the new printing parameters to be used to print each image based on the intended printing parameters, can control the printing process by controlling operation of the printing mechanism 106 to implement the new printing parameters, can control the transport of the card(s) throughout the system 100 and any other control operations necessary for operation of the system 100. The controller 108 can be located anywhere as long as it can be connected to and control operation of the individual components of the system 100 as well as control overall operation of the system 100.

With continued reference to FIG. 5, the system 100 can optionally include additional components. For example, the system 100 may optionally include a chip testing/programmer 110 and/or a magnetic strip encoder 112. The chip testing/programmer 110 is configured to perform contact or contactless testing of an integrated circuit chip on each card to test the functionality of the chip, as well as program the chip. Testing the functionality of the chip can include reading data from and/or writing data to the chip. In one embodiment, the chip testing/programmer 110 can be configured to simultaneously program the chips on a plurality of cards. The construction and operation of chip testing/programmers in card processing systems is well known in the art. The magnetic strip read/write encoder 112 is configured to read data from and/or encode data on a magnetic strip on each card (if the cards include a magnetic strip). The construction and operation of magnetic strip read/write testing devices in card processing systems is well known in the art.

The system 100 in FIG. 5 may also include optional other card processing mechanism(s) 114. One or more of the mechanism(s) 114 may be located between the card printing mechanism 106 and the chip programmer 110, and/or one or more of the mechanism(s) 114 may be located between the printing mechanism 106 and the output 104. The mechanism(s) 114 can be card processing mechanisms known in the art to perform card processing operations that are known in the art. For example, the card processing mechanism(s) 114 can be configured to perform one or more of embossing; indenting; laminating; laser marking using a laser; apply a topcoat; a quality control station that is configured to check the quality of personalization/processing applied to the cad(s); a radiation curing station to apply radiation to cure radiation curable ink; a security station that is configured to apply a security feature such as a holographic foil patch to the card(s); and other card processing operations.

As described above, at least one intended printing parameter of the printing mechanism is modified to at least one new printing parameter in real-time based on real-time processing of the image data of the image to be printed onto the card while the card is in the card personalization system. The at least one new printing parameter relates to the performance of the printing mechanism and how it will perform the printing of the image on the card.

The following are some specific non-limiting examples of printing parameters that can be modified from one card to the next based on the image to be printed. The following examples assume that the printing employed by the printing mechanism is DOD printing from one or more DOD printheads, and that the printing is multi-color printing for example using CMYK (cyan, magenta, yellow and black) ink.

### Example 1

### Counting the Number of Ink Drops on One or More Color Planes

In this example, the image data for the image to be printed is processed, for example by raster image processing, to generate a color plane for each color (C, M Y and K) to be printed. The number of ink drops needed for each color plane are counted. This can give a density of each color plane. The number of ink drops per color plane can give a better indication of the need for pinning (i.e. partial curing) the ink. For example, yellow and black ink may require pinning. Accordingly, for one card, the image processing may determine that based on the number of ink drops in the color planes, pinning is required for one or more color planes and thus set the printing mechanism to perform pinning (for each color plane or after the entire image is printed). For the next card in sequence, the image processing may determine that based on the number of ink drops in the color planes, pinning is not required and thus modify the printing parameters of the printing mechanism so that no pinning is performed.

### Example 2

Ink Load Per Row and/or Per Column

In this example, the image data for the image to be printed is processed to analyze the ink load or ink density per row (or from left to right; or from right to left) of the image to be printed and/or per column (or from top to bottom; or from bottom to top) of the image to be printed. Analyzing the ink distribution by row and column can indicate gradients and/or transitions in the ink. The gradients and/or transitions can then be used to determine which of the variable settings need to be modified to produce the best quality of image on the card.

### Example 3

### Ink Histograms

Histograms can be used for analyzing the image density and distribution. A histogram with a single wide peak could mean a smooth image and a larger wetout may be beneficial to get a smoother result, and no pinning would be used. A histogram with 2+ peaks would indicate a varying image with some transitions. This may suggest the need for pinning. Histograms with each ink panel can be used as well for more information. Accordingly, for one card, the histogram analysis of the image data of the image to be printed may indicate the single wide peak and the printing parameters modified so that no pinning is used when printing that image on that card. For the next card in sequence, the histogram analysis of the image data of the image to be printed may indicate 2+ peaks with the printing parameters modified so that pinning does take place when printing the image on that next card.

### Example 4

Any combination of examples 1, 2 and 3 can be used.

### Example 5

### Localized Image Analysis

Instead of analyzing the entire image, or as a supplement to analyzing the entire image, localized areas of the image to be printed can be analyzed. For example, a portion of the image to be printed (e.g. ½, ¼, ¾, any fraction thereof) could be analyzed, for example to count ink drops, determine ink load, etc. in that localized portion as described above. The smaller the area, the more information can be discerned about the image distribution.

In an embodiment, text, bar code, and other non-graphical data in the image to be printed may impact how a printing parameter is modified, and whether a printing parameter is modified. For example, barcodes and small fonts may require a different setting(s) than a larger font or a Serif-type font where more coverage is desired. In another example, white ink in DOD printing could also produce different results due to the size of the drops.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method of printing an image on a card in a card personalization system having a printing mechanism, comprising:
inputting the card onto a card path of the card personalization system from a card input;
after the card is input onto the card path, processing image data of the image to be printed on the card and based on the processing modifying an intended printing parameter to a new printing parameter;
and
printing at least a portion of the image on the card in the printing mechanism using the new printing parameter.

2. The method of claim 1, wherein processing the image data occurs during programming of a chip on the card in the card personalization system or after the programming of the chip on the card in the card personalization system.

3. The method of claim 1, wherein processing the image data occurs during magnetic encoding of a magnetic strip on the card in the card personalization system or after the magnetic encoding of the magnetic strip on the card in the card personalization system.

4. The method of claim 1, wherein the printing is drop-on-demand printing or thermal printing from a print ribbon.

5. The method of claim 1, wherein the printed portion of the image is a multi-color image.

6. The method of claim 1, wherein the image is a background image.

7. The method of claim 1, wherein the card is formed at least partially from polyvinyl chloride.

8. The method of claim 5, wherein processing the image data includes generating a plurality of color planes.

9. A method of printing images on cards in a card personalization system having a printing mechanism, comprising:
printing in sequence in the printing mechanism a first image on a first card and a second image on a second card;
wherein printing the first image on the first card comprises using a first set of printing parameters that are generated after the first card is input from a card input onto a card path of the card personalization system, the first set of printing parameters includes at least one new first printing parameter that is generated based on an intended first printing parameter;
wherein printing the second image on the second card comprises using a second set of printing parameters that are generated after the second card is input from the card input mechanism onto the card path of the card personalization system, the second set of printing parameters includes at least one new second printing parameter that is generated based on an intended second printing parameter; and
the second set of printing parameters differs from the first set of printing parameters.

10. The method of claim 9, wherein the at least one new first printing parameter is generated during programming of a chip on the first card or after the programming of the chip on the first card, and the at least one new second printing parameter is generated during programming of a chip on the second card or after the programming of the chip on the second card.

11. The method of claim 9, wherein the at least one new first printing parameter is generated during magnetic encoding of a magnetic strip on the first card or after the magnetic encoding of the magnetic strip on the first card, and the at least one new second printing parameter is generated during magnetic encoding of a magnetic strip on the second card or after the magnetic encoding of the magnetic strip on the second card.

12. The method of claim 9, wherein the printing mechanism is configured to perform drop-on-demand printing or thermal printing from a print ribbon.

13. The method of claim 9, wherein the first image and the second image are each a multi-color image.

14. The method of claim 9, wherein the first image and the second image are each a background image.

15. The method of claim 9, wherein the first card and the second card are each formed at least partially from polyvinyl chloride.

16. The method of claim 13, comprising processing first image data of the first image to generate a plurality of first color planes, and processing second image data of the second image to generate a plurality of second color planes.

17. The method of claim 9, comprising printing first personal data on the first card and printing second personal data on the second card, and the first personal data differs from the second personal data.

18. A method of printing images on cards in a card personalization system having a printing mechanism, comprising:
printing in sequence in the printing mechanism a first image on a first card and a second image on a second card;
wherein printing the first image on the first card comprises using a first set of printing parameters, the first set of printing parameters includes at least one new first printing parameter that is generated based on an intended first printing parameter;
wherein printing the second image on the second card comprises using a second set of printing parameters, the second set of printing parameters includes at least one new second printing parameter that is generated based on an intended second printing parameter; and
the second set of printing parameters differs from the first set of printing parameters.

19. The method of claim 18, comprising generating the at least one new first printing parameter after the first card is input from a card input onto a card path of the card personalization system; and generating the at least one new second printing parameter after the second card is input from the card input onto the card path of the card personalization system.

20. The method of claim 18, comprising generating the first set of printing parameters prior to the first card being input from a card input onto a card path of the card personalization system; and generating the second set of printing parameters prior to the second card being input from the card input onto the card path of the card personalization system.

21. The method of claim 20, comprising generating the first set of printing parameters and generating the second set of printing parameters at a location physically separate from the card personalization system.
